(19) United States
(12) Patent Application Publication
(10) Pub. No.: US 2022/0183436 A1
(43) Pub. Date: Jun. 16, 2022

(54) Identity-Locked Personal Item

(71) Applicants: Juliana Bastos Volpiani, Reston, VA (US); Pedro Stefanin Volpiani, Reston, VA (US)

(72) Inventors: Juliana Bastos Volpiani, Reston, VA (US); Pedro Stefanin Volpiani, Reston, VA (US)

(21) Appl. No.: 17/532,901

(22) Filed: Nov. 22, 2021

Related U.S. Application Data
(60) Provisional application No. 63/123,978, filed on Dec. 10, 2020.

(51) Int. Cl. A45C 13/10; G01S 1/04; H02S 10/40; G07C 9/00; A45C 3/06; A45C 15/00; H04N 5/225

(52) U.S. Cl. CPC A45C 13/10; G01S 1/0426; H02S 10/40; E05B 47/0001; A45C 3/06; A45C 15/00; H04N 5/2257; G07C 9/00706

(57) ABSTRACT

An identity-locked personal item is provided with a lock body configured to receive and release an engagement member upon receiving a matched biometric imprint from an authorized user. An actuator mechanism is connected to at least one capacitive surface and a controller with an integrated power supply inside the lock body, the lock body being further integrated into a secured container. The controller is configured to receive a contact datum from the capacitive surface, the actuator mechanism being operated upon recognition of a known datum or biometric signature.

The current application claims a priority to the U.S. Provisional Patent application Ser. No. 63/123,978 filed on Dec. 10, 2020.

### FIELD OF THE INVENTION

The present invention generally relates to the field of physical security, describing a biometric lock and locator apparatus directed towards securing a sealed personal bag or similar article. General considerations are made towards additional functionalities typical of various ‘smart’ devices, in addition to the more specific construction of the physical lock apparatus.

### BACKGROUND OF THE INVENTION

Padlocks, tumbler locks, shackles, and a variety of both digital and mechanical security devices are regularly used to physically secure valuables against unauthorized access. In particular, locking luggage and handbags are vulnerable—there are rarely equipped with the same kinds of security apparatuses that might be placed in a more permanent installation. This shortcoming is increasingly concerning as personal devices, credit cards, or other similar items may cause far-reaching harm if stolen. However, the conventional digitized security solutions available for doors and luggage are not immediately suitable for use in personal articles, said solutions being primarily directed towards immobile applications. These locks are typically characterized by bulky casings, excessive weight, and locking members that cannot properly engage the openings of said personal articles.

Therefore, it is proposed that a novel form of digitized personal security implement is desirable. The present invention aims to improve the security of anti-theft bags in the market today, using a smart lock system and gives confidence to the user in any day-to-day activity. The bag is easy to use and will provide peace of mind for people who travel or are in crowded spaces by ensuring that nobody may gain access to the personal affects of the user without being authorized by an integrated, user-coded biometric security mechanism integrated directly into the bag.

Additional advantages of the invention will be set forth in part in the description which follows, and in part will be obvious from the description, or may be learned by practice of the invention. Additional advantages of the invention may be realized and attained by means of the instrumentalities and combinations particularly pointed out in the detailed description of the invention section. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

FIG. 1 is a top-front-left perspective view of one embodiment of the present invention, wherein the personal item is in a sealed configuration.

FIG. 2 is an alternate configuration thereof, wherein the personal item is opened upon recognition of an authorized user.

FIG. 3 is an alternate configuration thereof, wherein the personal item is illustrated with a solar power capture system distributed across the personal item.

FIG. 4 is a partially exploded view thereof, wherein the personal item is shown partially delaminated to show internal composition.

FIG. 5 is a detail view of one embodiment of the present invention, specifically focusing on the locking mechanism thereof.

FIG. 6 is an exploded view thereof, wherein the explosion vectors are rendered in dashed-line.

FIG. 7A is a schematic view of the simplified logic employed by the present invention to form a lock-unlock determination using contact-based biometric input compared against a known-good reference.

FIG. 7B is a schematic view of the simplified logic employed by the present invention to form a lock-unlock determination using audio-based biometric input compared against a known-good reference.

FIG. 7C is a schematic view of the simplified logic employed by the present invention to form a lock-unlock determination using location-based geographic input compared against a known-good reference.

FIG. 7D is a schematic view of the simplified logic employed by the present invention to form a lock-unlock determination using visual-based pattern input compared against a known-good reference.

FIG. 8 is a schematic view of the simplified network diagram wherein the present invention received operable orders remotely from an authenticated external source.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

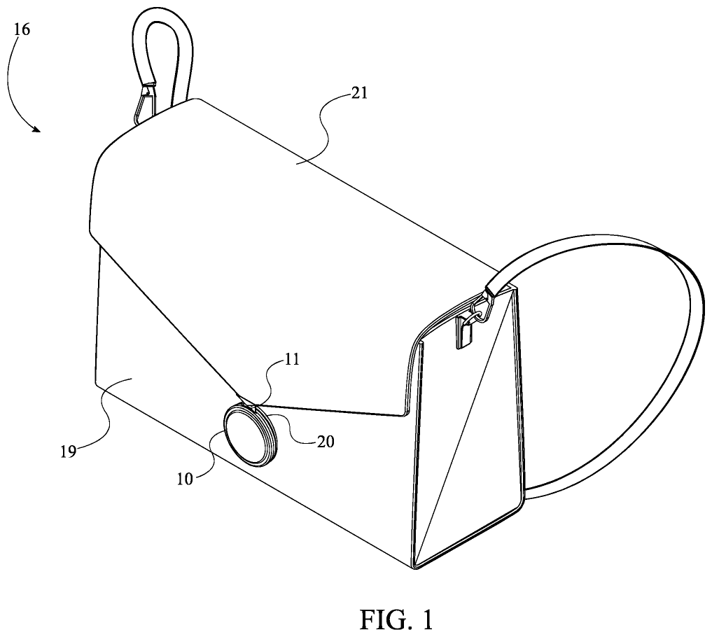

In reference to FIG. 1 through 8, the present invention is an identity-locked personal item provided to ensure that only authorized users are allowed to access the personal effects of the owner of any instance of the present invention. In an ideal embodiment, the present invention is configured as a handbag or purse employed by individual owners to increase the security of items carried on said users' person. More generally, the functional assembly described herein may be deployed in products of any form factor or description as may be realized by any reasonably skilled individual.

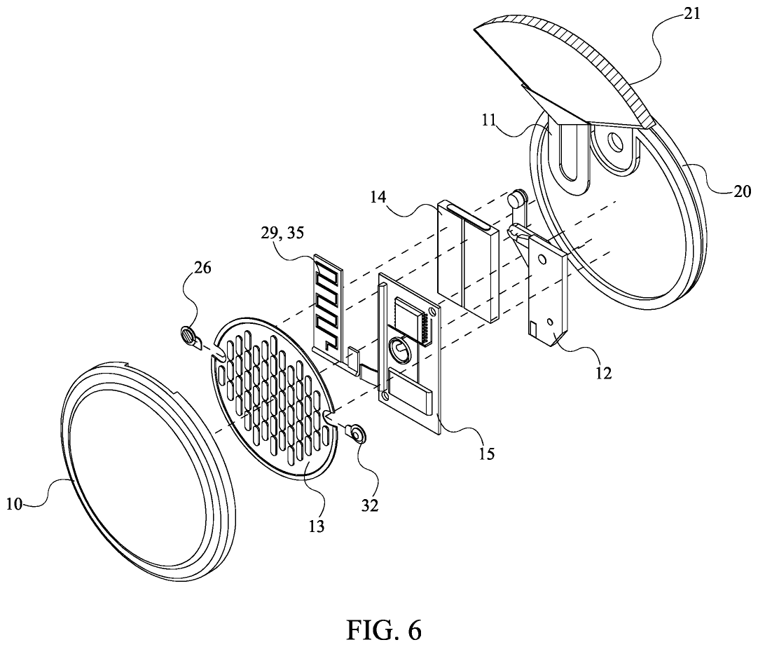

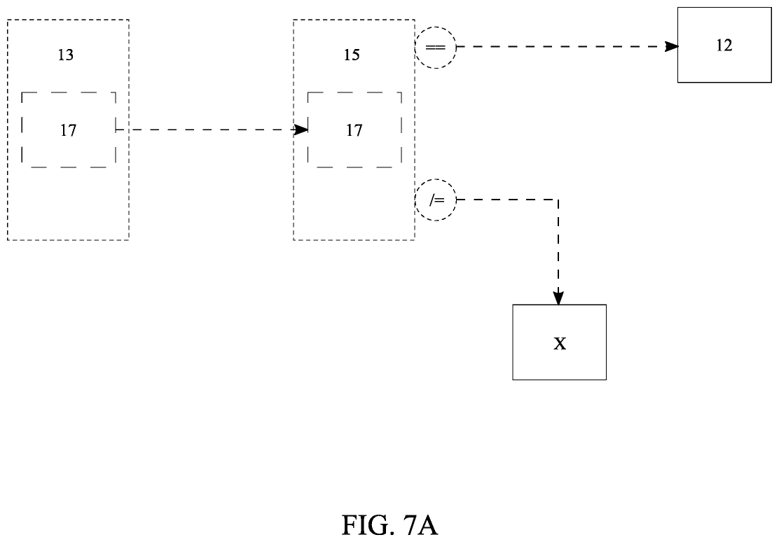

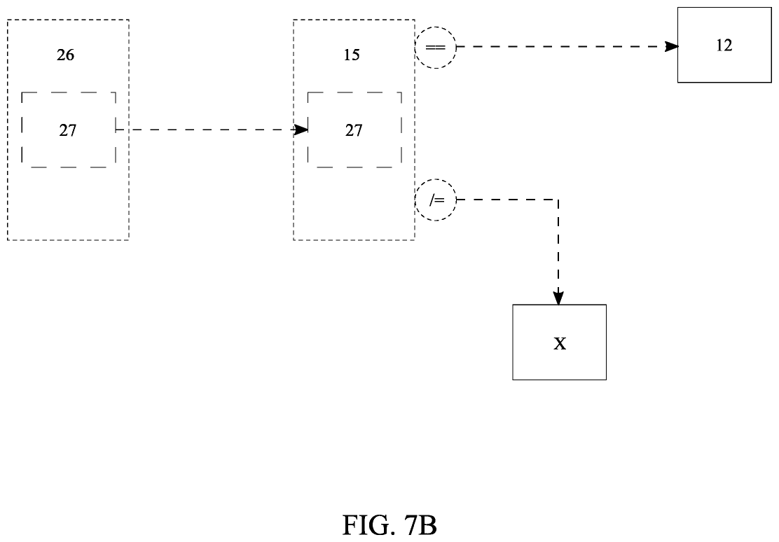

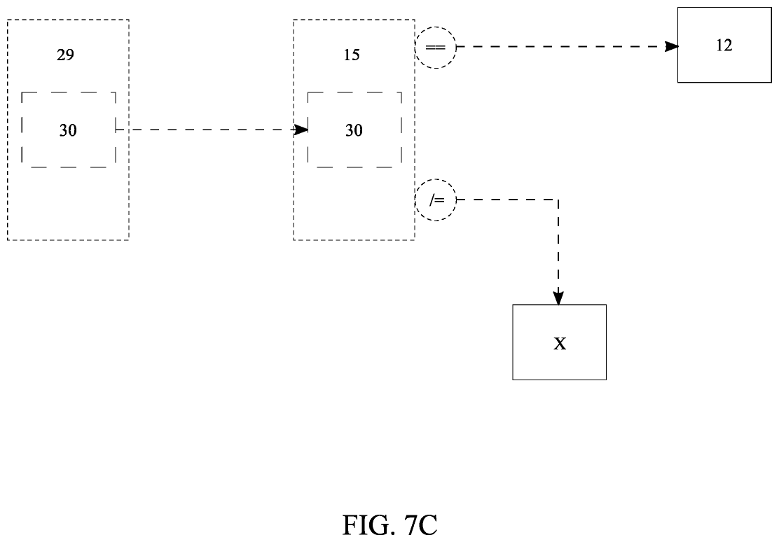

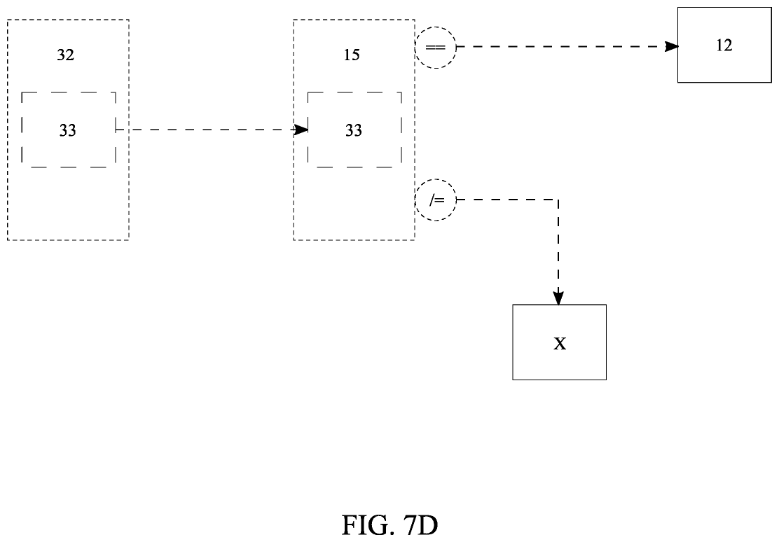

As shown in exemplary form in FIGS. 1 and 6, the present invention comprises a lock body 10, an engagement member 11, an actuator mechanism 12, at least one capacitive surface 13, a power supply 14, a controller 15, and a secured container 16. The lock body 10 refers to a hardened outer shell or support structure of suitable dimensions to contain the operable components of the present invention. Further, the lock body 10 is contemplated to embody passive security features of conventional combination locks or strongboxes, e.g., cut-resistant alloys, hardened external surfaces, irregular or concealed fasteners, or other means of frustrating forceful disassembly of the lock body 10. The actuator mechanism 12, power supply 14, and controller 15 are mounted into the lock body 10, wherein each of these operable components is ideally compartmentalized and unitized to prevent compromise of any single component allowing for compromise of the present invention entirely. Further, the controller 15 is electronically connected to the actuator mechanism 12 and the at least one capacitive surface 13, wherein the lock actuator mechanism 12 is configured to operably disengage from the engagement member 11 upon receipt of a contact datum 17 via the at least capacitive surface 13 as outline din FIG. 7A.

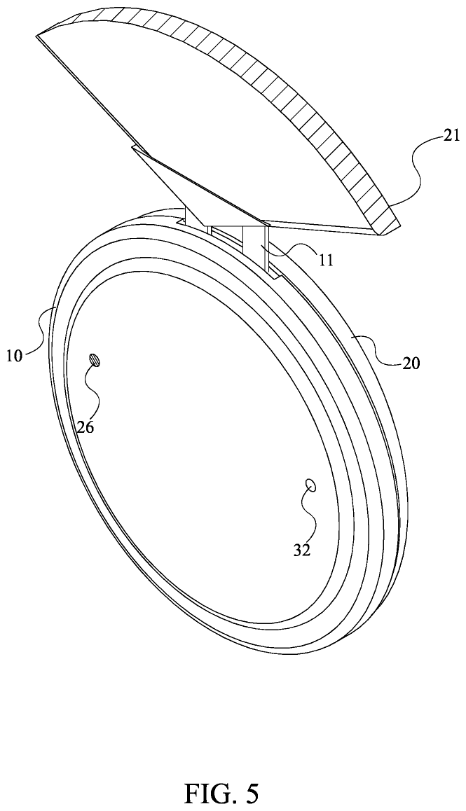

Accordingly, the capacitive surface 13 refers to any means of capturing a machine-readable metric suitable for establishing the identity of a user through direct contact, such as a fingerprint. The power supply 14 is electrically connected to the controller 15, wherein the controller 15 is configured to moderate the flow of electrical energy to the lock actuator mechanism 12 and the at least one capacitive surface 13. This arrangement defines the most simplistic interpretation of a lock-or-unlock logic, wherein the actuator mechanism 12 remains in a ‘locked’ configuration until provided operating power via the controller 15. In a preferred embodiment, the at least one capacitive surface 13 is positioned on the exterior of the lock body 10 as shown in FIG. 5 to enable direct access to the capacitive surface 13. However, it is considered that the lock body 10 may constitutes a deployable cover or cap in at least one embodiment to protect the capacitive surface 13 from incidental damage. The engagement member 11 is releasably engaged to the actuator mechanism 12, wherein the controller 15 moderates the actuation of the actuator mechanism 12 according to a preset or preprogrammed logical structure configured by each individual user. In the most-secure embodiment thereof, the controller 15 will only operate the actuator mechanism 12 upon recognition of a unique biometric signature specific to a single authorized user. Finally, the lock body 10 is attached to the secured container 16, wherein the engagement member 11 is configured to prevent access to the secured container 16. In the exemplary embodiment shown in FIG. 1 through 4, the secured container 16 generally refers to a personal bag and the engagement member 11 refers to the forward clasp of the primary compartment of said personal bag. However, as previously outlined, the functional arrangement of the actuator mechanism 12 and the engagement member 11 may be dispersed across any type of sealable luggage or package without departing from the original spirit and scope of the present invention.

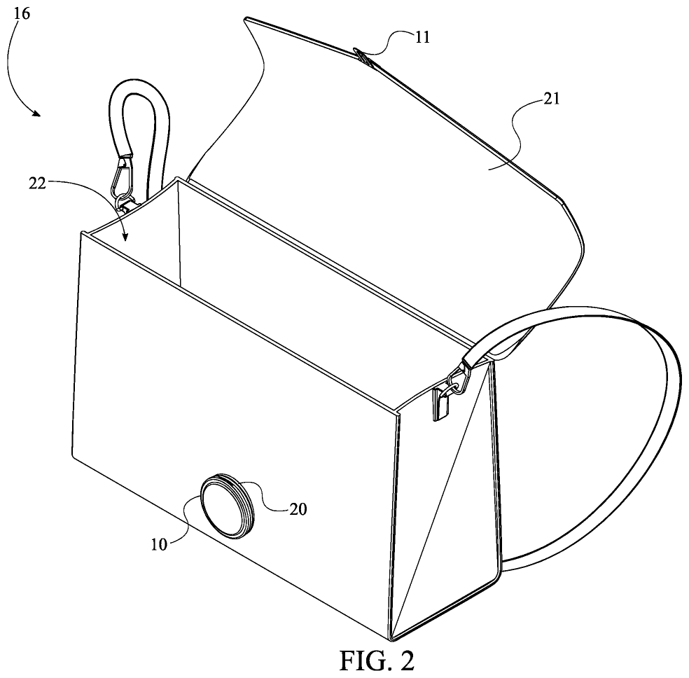

In reference to the exemplary embodiment in FIGS. 1 and 2, the secured container 16 comprises a container shell 19, a mounting plate 20, a closure panel 21, and a container aperture 22. The container shell 19 and the closure panel 21 broadly refer to the main section of any bag or parcel and the cap, cover, or flap positioned over any opening thereof. Accordingly, the container aperture 22 refers directly to the opening of the container shell 19, as indicated in FIG. 2. The mounting plate 20 is integrated to the container body adjacent to the container aperture 22 with the lock body 10 being attached to the mounting plate 20 in turn. The mounting plate 20 ideally provides a reinforced joint between the material of the container shell 19 and the lock body 10 to prevent unauthorized access by forcibly severing the lock body 10 for the container shell 19. Any frustration of this type of brute-force access can be proposed as a success, even if the mounting panel does not permeate the entirety of the container shell 19. The proximal arrangement of the lock body 10 to the container aperture 22 is generally considered to be an optimal location to capture the engagement member 11 as the closure panel 21 is positioned over the container aperture 22. Accordingly, the engagement member 11 is mounted to the closure panel 21 and the closure panel 21 is mounted to the container body, wherein the closure panel 21 is configured to operably occlude the container aperture 22. In at least one embodiment, the closure panel 21 is suitable rigid or form-retentive to align the engagement member 11 with the lock body 10 automatically as the closure panel 21 is moved to the closed position, thereby allowing for a ‘lock-on-close’ functionality that passively ensures that the secured container 16 is inaccessible without first releasing the engagement member 11 via the controller 15.

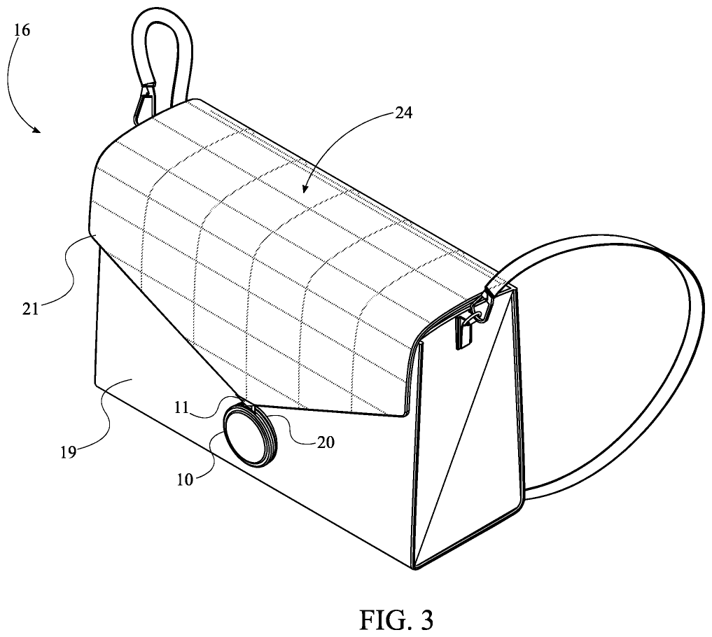

In addition to the internal power supply 14 providing operating power to the controller 15 and the actuator mechanism 12, it is proposed that the secured container 16 itself may serve as a discrete power source. More specifically, one embodiment of the present invention further comprises a photovoltaic array 24, wherein the photovoltaic array 24 constitutes a means of collecting ambient sunlight and converting said solar energy into useable energy within the power supply 14. In reference to FIG. 3, the photovoltaic array 24 is distributed across the secured container 16 and is electrically connected to the power supply 14 through the lock body 10. In a preferred configuration, the photovoltaic array 24 is positioned on the upper facets or segments of the container shell 19 to maximize exposure to sunlight, i.e., the largest expanses of planar surface that are positioned on a directional top of any embodiment of the present invention. Further, the lock body 10 may be configured to serve as a junction for any disparate elements of the photovoltaic array 24, wherein the lock body 10 conjoins the otherwise separated regions of the photovoltaic array 24 when the secured container 16 is in a closed configuration.

It is further proposed that the controller 15 may be configured to recognize additional unique signatures of an authorized user to provide alternative means of accessing the secured container 16. Accordingly, one embodiment of the present invention comprises a microphone 26 configured to detect ambient sound, specifically voices and finer features of spoken words. The microphone 26 is mounted into the lock body 10 and electrically connected to the power supply 14 to provide any necessary operating power to the microphone 26. The microphone 26 is further electronically connected to the lock actuator mechanism 12, wherein the lock actuator mechanism 12 is configured to operably disengage from the engagement member 11 upon receipt of an audio datum 27 via the microphone 26. The audio datum 27 is ideally a password or phrase configured by an authorized user and stored within the controller 15 for comparison to the audio datum 27 as outlined in FIG. 7B. It is further considered that the microphone 26 may be configured to detect alternate phrases and commands, wherein the controller 15 may also be configured to respond to these recognized messages in specific ways according to the unique configurations of each user.

Another embodiment of the present invention comprises a location beacon 29 mounted into the lock body 10. The location beacon 29 generally refers to a global positioning system (GPS) radio similar universal position-reporting component suitable for providing a digitized reference to the location of the location beacon 29. The location beacon 29 is electrically connected to the power supply 14 to provide any requisite operating power, wherein the location beacon 29 is expected to periodically update the position of the present invention to the controller 15 and limit power consumption according to available resources. The location beacon 29 is further electronically connected to the lock actuator mechanism 12, wherein the lock actuator mechanism 12 is configured to operably disengage from the engagement member 11 upon receipt of a positional datum 30 via the location beacon 29. In reference to FIG. 7C. The comparator to the positional datum 30 is ideally defined by a geofenced grid or recorded boundary within which the actuator mechanism 12 may be disengaged. It is further considered that the positional datum 30 may be utilized as a sub-check or a portion of a consensus-based lock-unlock determination made by the processor. For example, the lock actuator may remain engaged even upon receipt of an authorized audio datum 27 if the positional datum 30 places the present invention outside of an allowed boundary. Likewise, the contact datum 17 may be disregarded if the positional datum 30 places the present invention an excessive distance from another known position to which the location beacon 29 draws reference, e.g., another instance of the location beacon 29 being used by the same user.

It is further considered that an embodiment of the present invention may provide at least one camera 32 mounted into the lock body 10. The at least one camera 32 is electrically connected to the power supply 14, including at least one embodiment of the at least one camera 32 that is always-on and operational to capture relevant unlocking attempts or to capture the identities of potential thieves attempting to access the secured container 16. Accordingly, the at least one camera 32 is electronically connected to the lock actuator mechanism 12, wherein the lock actuator mechanism 12 is configured to operably disengage from the engagement member 11 upon receipt of a visual datum 33 via the at least one camera 32 as outlined in FIG. 7D. The visual datum 33 most directly refers to the facial scans or recognizable facial features of an authorized user, but the range of potential programmable instances of the visual datum 33 should not be construed as limited to biometric data only. As referenced above the at least one camera 32 may additionally be configured as a theft-prevention or asset recovery tool by surreptitiously capturing identifying images of potential thieves.

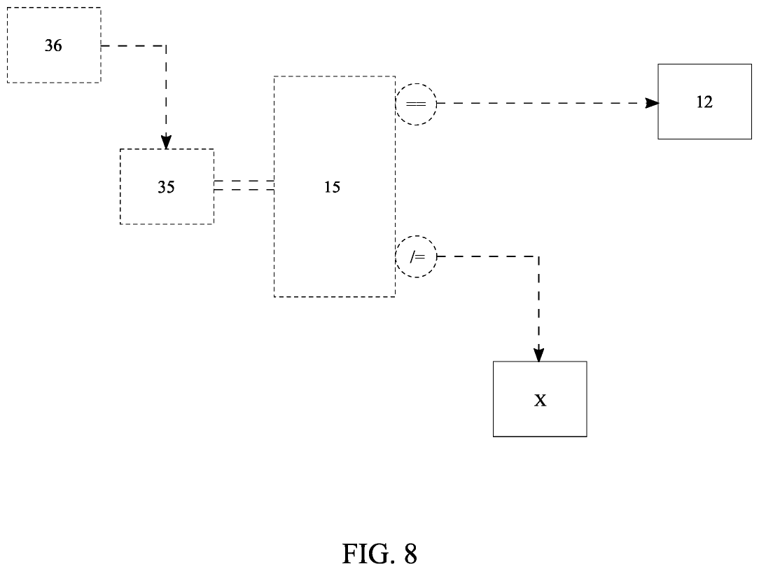

In yet another embodiment of the present invention, the present invention comprises a transceiver array 35 mounted into the lock body 10 as shown in FIG. 6. The transceiver array 35 is electrically connected to the power supply 14 and electronically connected to the lock actuator mechanism 12 to enable the transceiver array 35 to directly subrogate any functions typically reserved for the controller 15 in at least one use-case. This arrangement is typically associated with the use of another computer, tablet, phone, or other ‘smart’ device being used as a surrogate instance of the controller 15 via the transceiver as outlined in FIG. 8. More generally, the transceiver array 35 is configured to wirelessly connect to at least one external terminal 36, wherein the present invention may provide a platform for more conventional functions typically associated with smart devices. It is additionally considered that the transceiver array 35 may enable the actuator mechanism 12 to engage other personal devices via near-field of long-range wireless connections such as Bluetooth, Wi-Fi, cellular networks, or any other type or wireless communication as may be known in the field. This networked arrangement enables the present invention to act as a message relay for common message formats, such as call-waiting notices, text messages, scheduled event alarms, weather updates, or other functions typically associated with a smartphone/smartwatch pairing.

In the broadest conception of the present invention, the controller 15 is contemplated to define any type or variety of logical operator as might be suitable for the operation of the present invention across the varied embodiments outlined herein. More specifically, the controller 15 may comprise a processor, an internal storage volume, a motor controller 15, or any other type of logical operator of equivalent function as may be suitable for integration to any embodiment of the present invention. The processor is ideally a mobile-class multicore processor suitable for performing any functions typically associated with a smartphone, smartwatch, or other comparable personal electronic device. The volume of internal storage is interlinked to the processor in support of this functionality, defining a volume of writeable digital storage space suitable for short-term data handling or longer-term storage of personal files such as photos, music, personal calendars, notes, or other user-generated data. In one configuration, the controller 15 may define a standalone personal electronic device or user terminal. In at least one conceivable use-case, the controller 15 may be configured to seize after a user fails to authenticate after repeated attempts or if the controller 15 receives a remote lockdown order. In this mode the engagement member 11 will be locked into the lock body 10 until a hard-reset or preset all-clear code is received, regardless of the input of appropriate passcodes of biometrics in the interim.

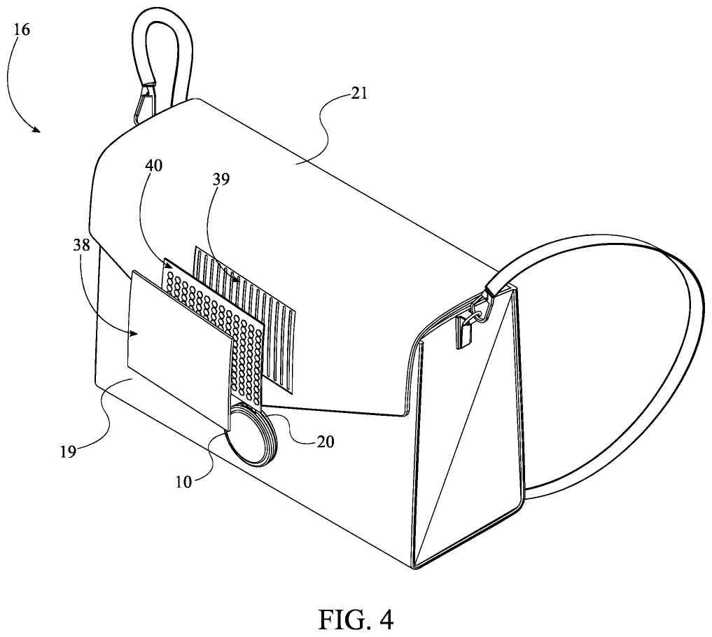

The secured container 16 may be further improved as a theft-resistant enclosure by layering or laminating multiple separate materials into a single coherent textile to create a durable instance of the container shell 19. In the embodiment shown in FIG. 4, the container shell 19 comprises an exterior layer 38, an interior layer 39, and an interstitial layer 40. The exterior layer 38 and the interior layer 39 are perimetrically attached about the container aperture 22 and the interstitial layer 40 is disposed between the exterior layer 38 and the interior layer 39. The superposition of the exterior layer 38 onto the interstitial layer 40 enables a durable outer coating to be applied directly onto the interstitial layer 40 as a supporting substrate during manufacture of the container shell 19. Further, the interior layer 39 may constitute a compressible or water-tight material without requiring that said same material retain the durability of the outer layer. To wit, the separation of the layers across the interstitial layer 40 enables the material qualities of the exterior layer 38 and the interior layer 39 to be drastically different, and therefore more flexible to the individual needs of a user.

Further, it is proposed that the interstitial layer 40 may be interchanged or reconfigured to protect the contents of the container shell 19, or the user themselves, dependent upon the individual design selections of any individual user. In one instance, the interstitial layer 40 comprises a radio-frequency blocking material to prevent any technically adept thieves from passively scanning any radio-frequency identification (RFID) chips within the secured container 16. RFID chips are now commonly associated with bank cards, personal identification, access keys, and a variety of other sensitive data-storage tokens that a user may wish to shield against passive scanning attacks. It is further noted that the position of the transceiver array 35 within the lock body 10 will not prevent the transceiver array 35 from functioning appropriately, provided that any signal source is not directly obstructed by the secured container 16.

In another embodiment, the interstitial layer 40 is a fire-resistant material. This configuration enables the contents of the container shell 19 to survive total-loss scenarios, such as house fires, in which the container shell 19 may be relied upon as a safe repository for vital documents or cash stores. It is further proposed that the fire-resistant material may be overlaid or superimposed onto the radio-frequency blocking material in at least one instance, wherein a user may benefit from both measures of protection.

In yet another embodiment, the interstitial layer 40 is a ballistic protective material. This embodiment is primarily directed towards defeating potential thieves utilizing brute-force entry methods to compromise the container shell 19, but the inherent benefits to personal protection are also presented as a potential benefit. Further, this embodiment offers enhanced durability of the interstitial layer 40 owing to the immense tensile strength of any ballistic protective material that may be selected by any reasonably skilled individual. As with the above-outlined embodiments, the ballistic protective material may be overlaid or integrated to any other constituent material of the interstitial layer 40, further compounding the functionality of the interstitial layer 40 across multiple conceivable embodiments.

Although the invention has been explained in relation to its preferred embodiment, it is to be understood that many other possible modifications and variations can be made without departing from the spirit and scope of the invention as hereinafter claimed.

What is claimed is:

1. An identity-locked personal item comprising:
a lock body;
an engagement member;
an actuator mechanism;
at least one capacitive surface;
a power supply;
a controller;
a secured container;
the actuator mechanism, power supply, and controller being mounted into the lock body;
the controller being electronically connected to the actuator mechanism and the at least one capacitive surface, wherein the lock actuator mechanism is configured to operably disengage from the engagement member upon receipt of a contact datum via the at least capacitive surface;
the power supply being electrically connected to the controller, wherein the controller is configured to moderate the flow of electrical energy to the lock actuator mechanism and the at least one capacitive surface;
the at least one capacitive surface being positioned on the exterior of the lock body;
the engagement member being releasably engaged to the actuator mechanism, wherein the controller moderates the actuation of the actuator mechanism; and
the lock body being attached to the secured container, wherein the engagement member is configured to prevent access to the secured container.

2. The identity-locked personal item as claimed in claim 1 comprising:
the secured container comprising a container shell, a mounting plate, a closure panel, and a container aperture;
the mounting plate being integrated to the container body adjacent to the container aperture;
the lock body being attached to the mounting plate;
the engagement member being mounted to the closure panel; and
the closure panel being mounted to the container body, wherein the closure panel is configured to operably occlude the container aperture.

3. The identity-locked personal item as claimed in claim 1 comprising:
a photovoltaic array;
the photovoltaic array being distributed across the secured container; and
the photovoltaic array being electrically connected to the power supply through the lock body.

4. The identity-locked personal item as claimed in claim 1 comprising:
a microphone;
the microphone being mounted into the lock body;
the microphone being electrically connected to the power supply; and
the microphone being electronically connected to the lock actuator mechanism, wherein the lock actuator mechanism is configured to operably disengage from the engagement member upon receipt of an audio datum via the microphone.

5. The identity-locked personal item as claimed in claim 1 comprising:
a location beacon;
the location beacon being mounted into the lock body;
the location beacon being electrically connected to the power supply; and
the location beacon being electronically connected to the lock actuator mechanism, wherein the lock actuator mechanism is configured to operably disengage from the engagement member upon receipt of a positional datum via the location beacon.

6. The identity-locked personal item as claimed in claim 1 comprising:
at least one camera;
the at least one camera being mounted into the lock body;
the at least one camera being electrically connected to the power supply; and
the at least one camera being electronically connected to the lock actuator mechanism, wherein the lock actuator mechanism is configured to operably disengage from the engagement member upon receipt of a visual datum via the at least one camera.

7. The identity-locked personal item as claimed in claim 1 comprising:
a transceiver array;
the transceiver array being mounted into the lock body;
the transceiver array being electrically connected to the power supply and electronically connected to the lock actuator mechanism; and
the transceiver array being configured to wirelessly connect to at least one external terminal.

8. The identity-locked personal item as claimed in claim 2 comprising:
the container shell comprising an exterior layer, an interior layer, and an interstitial layer;
the exterior layer and the interior layer being perimetrically attached about the container aperture; and
the interstitial layer being disposed between the exterior layer and the interior layer.

9. The identity-locked personal item as claimed in claim 8 wherein:
the interstitial layer comprises a radio-frequency blocking material.

10. The identity-locked personal item as claimed in claim 8 wherein:
the interstitial layer comprises a fire-resistant material.

11. The identity-locked personal item as claimed in claim 8 wherein:
the interstitial layer comprises a ballistic protective material.

12. The identity-locked personal item comprising:
a lock body;
an engagement member;
an actuator mechanism;
at least one capacitive surface;
a power supply;
a controller;
a secured container;
the actuator mechanism, power supply, and controller being mounted into the lock body;
the controller being electronically connected to the actuator mechanism and the at least one capacitive surface, wherein the lock actuator mechanism is configured to operably disengage from the engagement member upon receipt of a contact datum via the at least capacitive surface;
the power supply being electrically connected to the controller, wherein the controller is configured to moderate the flow of electrical energy to the lock actuator mechanism and the at least one capacitive surface;
the at least one capacitive surface being positioned on the exterior of the lock body;
the engagement member being releasably engaged to the actuator mechanism, wherein the controller moderates the actuation of the actuator mechanism;
the lock body being attached to the secured container, wherein the engagement member is configured to prevent access to the secured container;
the secured container comprising a container shell, a mounting plate, a closure panel, and a container aperture;
the mounting plate being integrated to the container body adjacent to the container aperture;
the lock body being attached to the mounting plate;
the engagement member being mounted to the closure panel;
the closure panel being mounted to the container body, wherein the closure panel is configured to operably occlude the container aperture;
the container shell comprising an exterior layer, an interior layer, and an interstitial layer;
the exterior layer and the interior layer being perimetrically attached about the container aperture; and
the interstitial layer being disposed between the exterior layer and the interior layer.

13. The identity-locked personal item as claimed in claim 12 comprising:
a photovoltaic array;
the photovoltaic array being distributed across the secured container; and
the photovoltaic array being electrically connected to the power supply through the lock body.

14. The identity-locked personal item as claimed in claim 12 comprising:
a microphone;
the microphone being mounted into the lock body;
the microphone being electrically connected to the power supply; and
the microphone being electronically connected to the lock actuator mechanism, wherein the lock actuator mechanism is configured to operably disengage from the engagement member upon receipt of an audio datum via the microphone.

15. The identity-locked personal item as claimed in claim 12 comprising:
a location beacon;
the location beacon being mounted into the lock body;
the location beacon being electrically connected to the power supply; and
the location beacon being electronically connected to the lock actuator mechanism, wherein the lock actuator mechanism is configured to operably disengage from the engagement member upon receipt of a positional datum via the location beacon.

16. The identity-locked personal item as claimed in claim 12 comprising:
at least one camera;
the at least one camera being mounted into the lock body;
the at least one camera being electrically connected to the power supply; and
the at least one camera being electronically connected to the lock actuator mechanism, wherein the lock actuator mechanism is configured to operably disengage from the engagement member upon receipt of a visual datum via the at least one camera.

17. The identity-locked personal item as claimed in claim 12 comprising:
a transceiver array;
the transceiver array being mounted into the lock body;
the transceiver array being electrically connected to the power supply and electronically connected to the lock actuator mechanism; and
the transceiver array being configured to wirelessly connect to at least one external terminal.

18. The identity-locked personal item as claimed in claim 12 wherein:
the interstitial layer comprises a radio-frequency blocking material.

19. The identity-locked personal item as claimed in claim 12 wherein:
the interstitial layer comprises a fire-resistant material.

20. The identity-locked personal item as claimed in claim 12 wherein:
the interstitial layer comprises a ballistic protective material.
